(19) United States
(12) Patent Application Publication
(10) Pub. No.: US 2009/0140470 A1
(43) Pub. Date: Jun. 4, 2009

(54) Article of Footwear of Nonwoven Material and Method of Manufacturing Same

(75) Inventors: Bhupesh Dua, Portland, OR (US); Edward N. Thomas, Portland, OR (US)

Correspondence Address: BANNER & WITCOFF, LTD., 28 STATE STREET, 28th FLOOR, BOSTON, MA, 02109-9601, US

(73) Assignee: NIKE, INC., Beaverton, OR (US)

(21) Appl. No.: 12/369,156

(22) Filed: Feb. 11, 2009

Related U.S. Application Data
(62) Division of application No. 11/143,260, filed on Jun. 2, 2005, now abandoned.

(51) Int. Cl. B29C 47/00

(52) U.S. Cl. 264/555; 264/171.21

(57) ABSTRACT

A method of forming a portion of an article of footwear includes the steps of providing a last having an exterior surface, extruding a plurality of polymeric fibers, projecting a stream of the extruded polymeric fibers onto the last to form a mat having the shape of the exterior of the last, and subjecting the mat to heat and pressure in a mold.

### RELATED APPLICATIONS

This application is a divisional application of U.S. application Ser. No. 11/143,260, filed on Jun. 2, 2005, which is incorporated herein by reference in its entirety.

### FIELD OF THE INVENTION

This invention relates to an article of footwear formed of a nonwoven material and a method of manufacturing an article of footwear formed of a nonwoven material.

### BACKGROUND OF THE INVENTION

Nonwoven fabrics, herein defined as structures made by bonding and/or interlocking polymeric fibers by mechanical or thermal means, are commonly used in many industries for many applications including, for example: (i) medical products, including surgical gowns, drapes, face masks, bouffant caps, surgical caps, footwear coverings, and slippers; (ii) protective coverings for automobiles, boats, airplanes, bicycles, lawn furniture, lawn mowers, and grills; (iii) apparel, including industrial work wear, pants, shirts, jackets, gloves, headwear, and socks; (iv) personal care products such as diapers, training pants, adult incontinence products, and feminine hygiene products; and (v) filtration.

Two common methods of forming nonwoven fabrics are melt-blowing and spunbonding. The melt-blowing process typically includes extruding a molten thermoplastic material through a plurality of fine die capillaries to form molten fibers. The fibers enter a high velocity gas stream, usually air, which attenuates the fibers so as to reduce their diameters. Thereafter, the high-velocity gas stream deposits the fibers on a collecting surface to form a substantially planar fabric, commonly referred to as a bat, mat web or sheet, which is comprised of randomly disbursed fibers. Patents that are representative of the melt-blowing process include U.S. Pat. No. 3,825,379 to Lohcamp et al. as well as U.S. Pat. No. 4,714,647 to Shipp, Jr. et al.

In contrast, the spunbonding process typically includes extruding a molten thermoplastic material through a plurality of fine spinnerette capillaries to form molten fibers. The fibers then enter a gas stream having less velocity than that of the melt-blowing process. The gas stream reduces the diameters of the fibers and deposits the fibers on a collecting surface, thereby forming a substantially planar fabric. Patents that are representative of the spunbonding process include U.S. Pat. No. 3,692,618 to Dorschner et al. and U.S. Pat. No. 4,340,563 to Appel et al. The difference between melt-blowing and spunbonding relates to the continuity and diameter of the fibers. Whereas melt-blown fibers have diameters that are generally smaller than 10 microns, spunbonded fibers have diameters that are generally between 10 and 30 microns. Melt-blown fibers often include both continuous and discontinuous fibers, since their smaller diameters tends to result in breakage of the continuous fibers, as contrasted with spunbond fibers that include primarily continuous fibers.

The majority of patents relating to the manufacture of nonwoven fabrics focus on the formation of a substantially planar material having a uniform thickness. However, U.S. Pat. No. 6,146,580 to Bontaites, Jr. discloses a method of manufacturing a nonwoven materials in which fibers are deposited on a contoured drum as the drum rotates. The result is a substantially planar material having the contour of the drum imprinted on one surface. Furthermore, the process discloses the manufacture of surgical masks using a form in the shape of a surgical mask. U.S. Pat. No. 5,575,874 to Griesbach, III et al. also discloses a process by which a textured or perforated material is formed.

Melt-blown and spunbonded fabrics have been incorporated into footwear in applications including coverings, composite uppers and insoles, and combination nonwovens. In relation to coverings, the primary use for nonwoven materials appears to be for medical products including footwear coverings and slippers. Patents assigned to Kimberly-Clark Worldwide, Inc., including U.S. Pat. Nos. 5,952,252; 5,939,341; 5,695,377; 5,688,157; and 5,652,051, are exemplary of such uses. In combination with other materials, nonwoven fabrics have been incorporated into shoe uppers and insoles. U.S. Pat. No. 4,603,075 to Dergarabedian discloses an insole composite comprised of a nonwoven fabric and woven polymeric scrim that are saturated with a curable or cross-linkable polymer. U.S. Pat. No. 4,663,222 to Ohue et al. discloses a nonwoven fabric that is heat-bonded to the inner side of a leather shoe to improve comfort and impart resistance to rain and water. U.S. Pat. No. 4,426,420 to Likhyani discloses a spunbonded fabric containing both elastic and non-elastic fibers so as to impart greater stretch and resilience to the fabric. A similar process for melt-blown fibers is disclosed in U.S. Pat. No. 5,238,733 to Joseph et al.

It is an object of the present invention to provide a method of producing an article of footwear formed of nonwoven material that reduces or overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

The principles of the invention may be used to advantage to provide a method of forming an article of footwear that includes a step of depositing polymeric fibers onto a surface of a last to form a nonwoven material having a shape that corresponds with the surface of the last. The nonwoven material may then be incorporated into an article of footwear. Such footwear provides improved breathability and moldability, abrasion resistance, stretch and recovery, water resistance, and recyclability.

In accordance with a first aspect, a method of forming a portion of an article of footwear includes the steps of providing a last having an exterior surface, extruding a plurality of polymeric fibers, projecting a stream of the extruded polymeric fibers onto the last to form a mat having the shape of the exterior of the last, and subjecting the mat to heat and pressure in a mold.

In accordance with another aspect, a method of forming an article of footwear includes the steps of providing a last having an exterior surface, providing a vacuum at the exterior surface of the last, extruding a plurality of polymeric fibers, depositing at least some of the polymeric fibers onto the last to form a mat having the shape of the exterior of the last, subjecting the mat to heat and pressure in a mold to form an upper, and securing the upper to a sole assembly.

In accordance with yet another aspect, an upper for an article of footwear includes a mat of nonwoven extruded polymeric fibers formed in a shape of an upper for an article of footwear, with the upper being seamless.

In accordance with a further aspect, an article of footwear includes a sole assembly, and an upper secured to the sole assembly, with the upper comprising a mat of nonwoven extruded polymeric fibers and being seamless.

In accordance with yet a further aspect, an upper of an article of footwear is formed by the steps of providing a last having an exterior surface, providing a vacuum at the exterior surface of the last, extruding a plurality of polymeric fibers, projecting a stream of the extruded polymeric fibers onto the last to form a mat having the shape of the exterior of the last, and subjecting the mat to heat and pressure in a mold to form an upper.

Substantial advantage is achieved by forming an article of footwear or an upper of an article of footwear of a nonwoven material. In particular, certain embodiments produce an upper that is breathable and comfortable, with improved moldability, abrasion resistance, stretch and recovery, and recyclability. Such footwear also has unique performance and aesthetic characteristics and reduced waste.

These and additional features and advantages disclosed here will be further understood from the following detailed disclosure of certain embodiments.

### BRIEF DESCRIPTION OF THE DRAWINGS

FIG. 1 is a perspective view of an article of footwear having an upper formed of nonwoven material in accordance with a certain embodiments.

FIG. 2 is a perspective view of a method of forming the upper of FIG. 1 by depositing nonwoven fibers on a last.

FIG. 3 is a perspective view of a mold used in the formation of the upper of the article of footwear of FIG. 1.

The figures referred to above are not drawn necessarily to scale and should be understood to provide a representation of the invention, illustrative of the principles involved. Some features of the article of footwear or upper of nonwoven material and their method of manufacture depicted in the drawings have been enlarged or distorted relative to others to facilitate explanation and understanding. The same reference numbers are used in the drawings for similar or identical components and features shown in various alternative embodiments. Uppers or articles of footwear of nonwoven material and the methods of manufacture as disclosed herein would have configurations and components determined, in part, by the intended application and environment in which they are used.

### DETAILED DESCRIPTION OF CERTAIN PREFERRED EMBODIMENTS

Referring to the drawings, wherein like numerals indicate like elements, an upper for an article of footwear a method of forming an article of footwear and in accordance with various embodiments are illustrated. The accompanying figures illustrate only the formation of an article of footwear intended for use on a left foot of a wearer. It is to be appreciated that the various embodiments also include a right article of footwear, such footwear being the mirror image of the left foot article depicted herein.

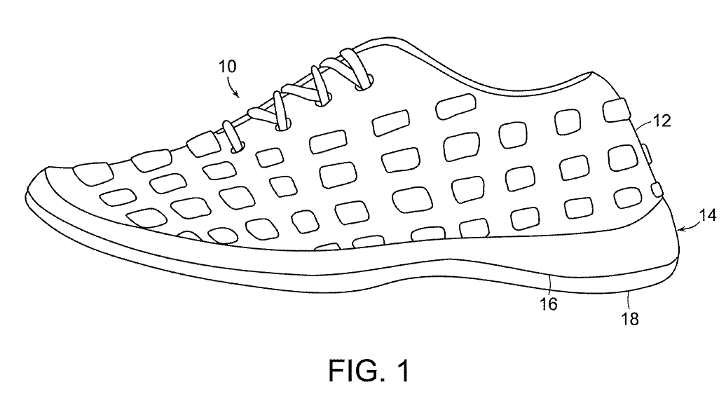

An article of footwear 10 in accordance certain embodiments is depicted in FIG. 1 and includes an upper 12. Attached to the lower portion of upper 12 is a conventional sole assembly 14. As seen here, sole assembly 14 includes a midsole 16 to which upper 12 is secured by adhesive, stitching or any other suitable fastening means. An outsole 18 is secured to midsole 16 by adhesive or other suitable fastening means. It is to be appreciated that is certain embodiments, sole assembly 14 may instead be a unitary structure and not formed of two separate midsole and outsole elements.

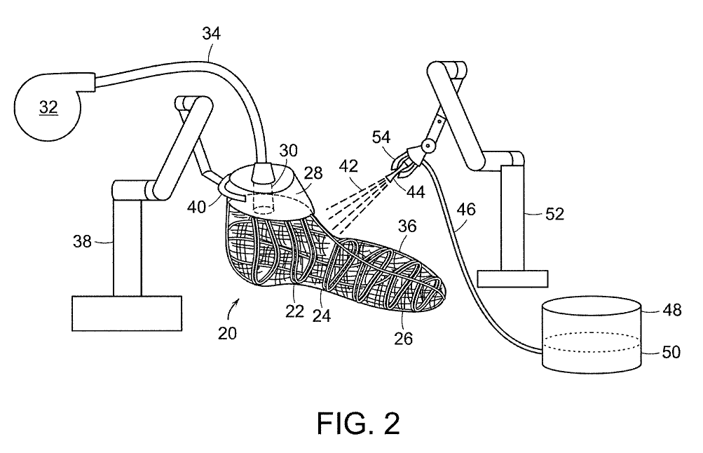

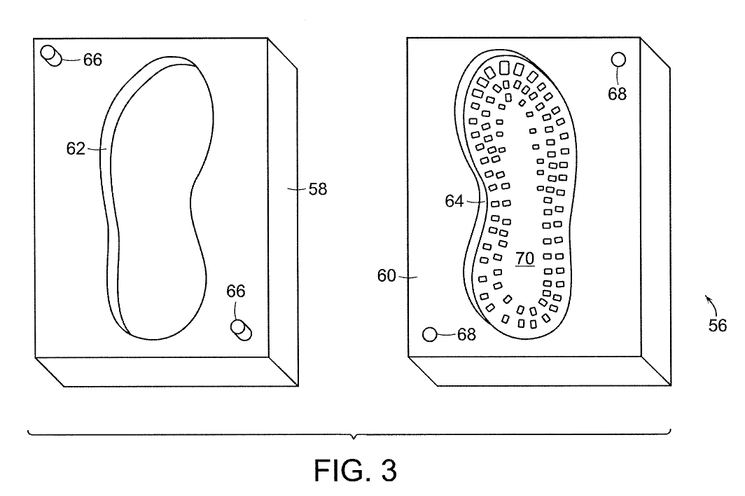

The construction of upper 12 is illustrated in FIGS. 2-3. As seen in FIG. 2, a last 20 is formed of a frame 22, which comprises a plurality of frame members 24 arranged such that they roughly define the shape of an upper for an article of footwear. Frame 22 may be formed of metal, e.g., aluminum. However, it is to be appreciated that other materials, such as plastics, or composite materials may be used to form frame 22. Other materials suitable for use as frame 22 will become readily apparent to those skilled in the art, given the benefit of this disclosure.

A mesh material 26 is disposed on the exterior of frame 22. In the illustrated embodiment, mesh material 26 is formed of metal, e.g., aluminum. Other suitable materials include fabrics woven with polyester or nylon filaments, perforated films, perforated plastic. It is to be appreciated that other materials, such as plastics or composite materials may be used to form mesh material 26. Other materials suitable for use as mesh material 26 will become readily apparent to those skilled in the art, given the benefit of this disclosure.

A mounting member 28 having an aperture 30 extending therethrough is secured to frame 22 at an upper edge of last 20 where the ankle opening of the upper to be formed is located. Aperture 30 is in fluid communication with the interior of frame 22. Mounting member 28 may be formed of an elastomeric material, metal, plastic or any other suitable material.

A vacuum source such as a pump 32 is connected by way of a conduit 34 to aperture 30 in mounting member 28. Pump 32 is used to apply a vacuum at an exterior surface 36 of last 20.

In various embodiments, a robot 38 is used to hold last 20 in a desired position. Robot 38 may be a multi-axis robot as shown here, thereby allowing last 20 to be manipulated in virtually any direction. Robot 38 has a gripper element 40 that securely holds last 20 in a desired position. As illustrated here, gripper element 40 is seen secured about mounting member 28.

A stream 42 of melt-blown or spunbonded fibers is projected onto last 20. The fibers collect on the surface of last 20 and form a continuous nonwoven covering. When a sufficient quantity of fibers collect on the surface of last 20, thereby forming upper 12, last 20 is removed from fiber stream 42 and permitted to cool. Last 20 may be removed from fiber stream 42 in many ways including physically moving last 20 away from fiber stream 42, redirecting fiber stream 42 so that it no longer impacts last 20, or by stopping the flow of fiber stream 42. Then, sole assembly 14 is attached to upper 12 using conventional techniques. Last 20 is removed from the interior of upper 12, thereby defining a recess for receiving the foot of a wearer. In certain embodiments, upper 12 is removed from last 20 prior to attachment of sole assembly 14. Upper 12 may be subject to further treatment prior to or after attachment of sole assembly 14 to upper 12.

In the illustrated embodiment, stream 42 is projected from a head or nozzle 44. Nozzle 44 is connected by a conduit 46 to a reservoir 48 of material 50. In certain embodiments, material 50 is a molten thermoplastic material, and nozzle 44 extrudes material 50 into a stream of melt-blown or spunbond material. It is to be appreciated that nozzle 44 can have any desired shape, and that its shape may vary based a desired characteristic of the fibers in stream 42 and based on the material 50 from which the fibers are extruded.

In the illustrated embodiment, a robot 52 is used to hold nozzle 44. Robot 52 may be a multi-axis robot as shown here, thereby allowing nozzle 44 to be manipulated in virtually any direction. Robot 52 has a gripper element 54 that securely holds nozzle 44 in a desired position. As illustrated here, gripper element 54 is seen secured about nozzle 44.

It is to be appreciated that in various embodiments, last 20 can be held in a fixed position and robot 52 can be used alone to manipulate stream 42 about last 20, thereby covering last 20 with the desired amount of material. In such an embodiment, robot 38 is not required. In other embodiments, nozzle 44 can be held in a fixed position and robot 38 can be used alone to manipulate the position of last 20 with respect to stream 42, thereby ensuring that the desired amount of material is deposited on last 20 in the appropriate areas. In such an embodiment, robot 52 is not required.

It is to be appreciated that upper 12 can be formed with varying thickness across its surface, thereby allowing upper 12 to be customized for a desired function. Thus, one or more portions of upper 12 can be formed of a thicker or thinner layer of material than that found in other portions, thereby altering characteristics, such as strength and flexibility of the material, throughout upper 12.

Material 50 that is used to form upper 12 can be any desired polymeric material capable of being spunbond or meltblown to produce a nonwoven fiber. Suitable examples of material 50 include, for example, thermoplastic urethane (TPU), polyurethane, or a high flex modulus polyether block amide, such as PEBAX®, which is manufactured by the Atofina Company. Other suitable materials used to produce nonwoven fibers used for forming articles of footwear will become readily apparent to those skilled in the art, given the benefit of this disclosure.

Once a desired quantity of fibers is deposited on last 20, upper 12 is then placed in a mold assembly 56, as seen in FIG. 3. In the illustrated embodiment, mold assembly 56 is formed of a first portion 58 and a second portion 60. A first recess 62 is formed in first portion 58 and a mating second recess 64 is formed in second portion 60. As illustrated here, first portion 58 has a plurality of pins 66 that are received in corresponding apertures 68 formed in second portion 60 in order to register and align first portion 58 with second portion 60. Mold assembly 56 is closed about upper 12 and subject to heat and pressure, which imparts additional strength to upper 12. Upper 12 is then removed from mold assembly 56 and last 20 is removed from upper 12. Sole assembly 14 can then be secured to upper 12 by stitching, adhesive or any other suitable fastening means.

Mold assembly 56 may be modified to impart surface irregularities in upper 12 during the molding process. As seen here, a plurality of recesses 70 are formed within recess 64 of second portion 60. These recesses 70 form projections 72 on upper 12 as seen in FIG. 1. In other embodiments, one or more projections can be formed in first recess 62 or second recess 64, which will form corresponding recesses in upper 12. It is to be appreciated that any number and configuration of surface irregularities can be formed on upper 12 by modifying the surface of first recess 62 of first portion 58 or second recess 64 of second portion 60. Thus, both the structure and aesthetic appeal of upper 12 can be varied by varying the configuration of mold assembly 56.

The surface of upper 12 can be sealed to make it more “film-like” during the molding process to provide a water resistant upper 12, thereby improving the functionality of upper 12. Upper 12, being formed of a non-woven material, advantageously exhibits improved breathability and moldability, as well as abrasion resistance, and improved stretch and recovery.

In certain embodiments, in which TPU is used to form upper 12, a sole assembly 14 comprising a midsole 16 and or an outsole 18, can be directly bonded to upper 12 without the need for primers or adhesive, thereby reducing the materials needed for assembly of footwear 10, and facilitating recycling of footwear 10.

In light of the foregoing disclosure of the invention and description of various embodiments, those skilled in this area of technology will readily understand that various modifications and adaptations can be made without departing from the scope and spirit of the invention. All such modifications and adaptations are intended to be covered by the following claims.

What is claimed is:

1. A method of forming a portion of an article of footwear comprising the steps of:
providing a last having an exterior surface;
extruding a plurality of polymeric fibers;
projecting a stream of the extruded polymeric fibers onto the last to form a mat having the shape of the exterior surface of the last; and
subjecting the mat to heat and pressure in a mold.

2. The method of claim 1, wherein the polymeric fibers are formed of polyurethane.

3. The method of claim 1, wherein the polymeric fibers are formed of a polyether block amide.

4. The method of claim 1, wherein the last comprises a frame covered by a mesh material.

5. The method of claim 4, wherein the frame and mesh material are formed of metal.

6. The method of claim 1, wherein the polymeric fibers are meltblown.

7. The method of claim 1, wherein the polymeric fibers are spunbond.

8. The method of claim 1, wherein the step of subjecting the mat to heat and pressure in the mold is performed with the mat on the last.

9. The method of claim 8, further comprising the step of removing the mat from the last.

10. The method of claim 1, wherein the mold includes at least one surface irregularity to form a mating surface irregularity on the mat.

11. The method of claim 1, wherein the mold includes a recess to form a mating projection on the mat.

12. The method of claim 1, wherein the mold includes a projection to form a mating recess on the mat.

13. The method of claim 1, further comprising the step of moving the last as the polymeric fibers are projected onto the last.

14. The method of claim 13, wherein the step of moving the last is performed with a robot.

15. The method of claim 1, further comprising the step of moving the stream of extruded polymeric fibers with respect to the last as the polymeric fibers are projected onto the last.

16. The method of claim 15, wherein the step of moving the stream of extruded polymeric fibers is performed with a robot.

17. The method of claim 1, further comprising the steps of moving the last and moving the stream of extruded polymeric fibers with respect to the last as the polymeric fibers are projected onto the last.

18. The method of claim 1, wherein the mat forms an upper for an article of footwear.

19. The method of claim 1, further comprising the step of providing a vacuum at the exterior surface of the last.

20. The method of claim 1, wherein the mat is water resistant.

21. A method of forming an article of footwear comprising the steps of:
providing a last having an exterior surface;
providing a vacuum at the exterior surface of the last;
extruding a plurality of polymeric fibers;
depositing at least some of the polymeric fibers onto the last to form a mat having the shape of the exterior of the last;
subjecting the mat to heat and pressure in a mold to form an upper; and
securing the upper to a sole assembly.

22. The method of claim 21, wherein the polymeric fibers are formed of polyurethane.

23. The method of claim 21, wherein the polymeric fibers are formed of polyether block amide.

24. The method of claim 21, wherein the last comprises a frame covered by a mesh material.

25. The method of claim 21, wherein the polymeric fibers are meltblown.

26. The method of claim 21, wherein the polymeric fibers are spunbond.

27. The method of claim 21, further comprising the step of removing the upper from the last.

28. The method of claim 21, wherein the mold includes at least one surface irregularity to form a mating surface irregularity on the upper.

28. The method of claim 21, wherein the mold includes a recess to form a mating projection on the upper.

30. The method of claim 21, wherein the mold includes a projection to form a mating recess on the upper.

31. The method of claim 21, wherein the sole assembly includes a midsole and an outsole.

32. The method of claim 20, further comprising the step of moving the last as the polymeric fibers are deposited on the last.

33. The method of claim 21, further comprising the step of moving the stream of extruded polymeric fibers with respect to the last.

34. The method of claim 21, further comprising the steps of moving the last as the polymeric fibers are deposited on the last and moving the stream of extruded polymeric fibers with respect to the last.

35. The method of claim 21, wherein the upper is water resistant.

36-65. (canceled)
